(19) United States
(12) Patent Application Publication
(10) Pub. No.: US 2024/0068428 A1
(43) Pub. Date: Feb. 29, 2024

(54) GAS INJECTOR AND METHOD FOR MANUFACTURING A GAS INJECTOR

(71) Applicant: Robert Bosch GmbH, Stuttgart (DE)

(72) Inventor: Martin Mueller, Moeglingen (DE)

(21) Appl. No.: 18/261,460

(22) PCT Filed: Dec. 1, 2021
(86) PCT No.: PCT/EP2021/083788

§ 371 Date: Aug. 23, 2023

(30) Foreign Application Priority Data
Jan. 18, 2021 (DE) 10 2021 200 392.3

(51) Int. Cl. F02M 21/02; F02M 51/06

(52) U.S. Cl. CPC F02M 21/0254; F02M 21/0206; F02M 21/0215; F02M 21/0257; F02M 51/0614; F02M 2200/16; F02M 2200/8084

(57) ABSTRACT

A gas injector for injecting a gaseous fuel. The gas injector includes: a magnetic actuator including an armature, an internal pole, and a coil; a closing element, which unblocks and closes a gas path at a valve seat, the armature being connected to the closing element; and at least one sealing device for sealing a space in the gas injector, the sealing device including a flexible sealant and at least one stiff intermediate element joined to the sealant, the at least one intermediate element being welded to a further component of the gas injector, the flexible sealant and the intermediate element being made from at least one first material, and the further component including a second material at least at the surface, and the at least one first material of the flexible sealant and of the intermediate element differing from the second material.

### FIELD

The present invention relates to a gas injector for injecting a gaseous fuel, in particular, hydrogen or natural gas or the like, in particular, for internal combustion engines. The gas injector is, in particular, configured for an intake manifold injection or a direct injection into a combustion chamber. The present invention furthermore provides a method for manufacturing the gas injector.

### BACKGROUND INFORMATION

Gas injectors are described in the related art in various embodiments. A problematic issue in the case of gas injectors, in the matter of principle, is that, due to the gaseous medium to be injected, no lubrication by the medium is possible, as is possible, for example, with fuel injectors injecting gasoline or diesel. This results in excessive wear during operation compared to fuel injectors for liquid fuels.

### SUMMARY

A gas injector according to an example embodiment of the present invention for injecting a gaseous fuel shows how a space in a gas injector may be sealed in an operationally safe manner using a flexible sealant. This space in the gas injector, in turn, may be used as a lubricant chamber and may thus seal the lubricant with respect to the gas path. The movable parts of the gas injector, such as, for example, the armature, are preferably situated in the space, in particular the lubricant chamber. The gas injector described here includes a magnetic actuator including an armature, an internal pole, and a coil. The armature is connected to a closing element so that the closing element is movable by the magnetic actuator. The closing element is situated and designed to release and to close the gas path at a valve seat of the gas injector. For this purpose, the armature is directly or indirectly mechanically connected to the closing element and thus enables a movement for opening and/or closing the gas injector. At least one sealing device is provided in the gas injector. This sealing device is designed and situated to seal the space in the gas injector. This space in the gas injector is preferably the described lubricant chamber. The individual sealing device includes a flexible sealant and at least one stiff intermediate element. The at least one intermediate element is welded to a “further component” of the gas injector. Within the scope of the present invention, the thin-walled flexible sealant only has to be joined, in particular, welded, to the intermediate element, no direct welding occurring between the sealant and the further component since the intermediate element is welded to the further component. To achieve an advantage in the process with respect to hydrogen embrittlement, care must be taken regarding the material selection: The materials for the sealant and the intermediate element are referred to as the “first material.” In the process, the intermediate element and the sealant may be made from the same “first material” or include two different “first materials.” It is crucial that the material (first material) of the sealant and of the intermediate element differs from a “second material” used here. The further component to which the intermediate element is welded includes this second material at least at the surface and is, in particular, made entirely from the second material.

Preferred embodiments and refinements of the present invention are disclosed herein.

According to an example embodiment of the present invention, it is, in particular, provided that the at least one first material is more resistant to hydrogen embrittlement than the second material. The first material is, in particular, an austenitic steel. Both the intermediate element and the flexible sealing element are preferably made from austenitic steel, it being possible to use two different or two identical austenitic steels for these two elements. Austenitic steel is also referred to as nickel-chromium steel. The reason is that, if nickel and chromium are added to a steel in sufficient quantities, the crystal structure changes to austenite. In the process, in particular, care is taken that the nickel content is sufficiently large since it improves the resistance to hydrogen embrittlement and, at the same time, maintains the austenitic structure. Hydrogen embrittlement describes, in particular, a form of brittle fracture or brittle cracking, which occurs when the material is exposed to hydrogen. A poorer resistance to hydrogen embrittlement describes, in particular, a greater crack growth rate, caused by the influence of hydrogen.

According to an example embodiment of the present invention, the further component to which the intermediate element is welded is hardened at least at the surface. In particular, the further component, at least at the surface, has a martensitic or precipitation-hardened structure. A martensitic steel is preferably used for the further component, to which, in particular, the martensitic structure is imparted by hardening heat treatment, at least at the surface. The further component may also be improved otherwise in terms of the hardness, e.g., by precipitation hardening.

According to an example embodiment of the present invention, during the welding between the intermediate element and the sealant, only two austenitic steels are welded together, so that no mixed structure arises here in the melt area of the weld seam; as a result, no risk of hydrogen embrittlement exists here. In the case of the weld seam between the intermediate element and the further component, a martensitic or otherwise partially hardened mixed structure is tolerated since, in this area, a limited decrease in strength, in particular due to hydrogen embrittlement, may be tolerated since the weld may be implemented here in a robust manner with a relatively large junction width. This is, in particular, possible since the intermediate element may be designed to be considerably more voluminous, in particular, thicker, than the flexible sealant.

According to an example embodiment of the present invention, the flexible sealant is, in particular, made up of metal. The flexible sealant is, in particular, a metal bellows, a metal membrane, or a metal hose. In particular, the austenitic steel is used for the flexible sealant since this material is easy to form and does not exhibit any hydrogen embrittlement with hydrogen-containing fuel.

According to an example embodiment of the present invention, the stiff intermediate element is preferably annularly closed. The stiff intermediate element is fixedly joined to the flexible sealant or manufactured integrally with the flexible sealant. Preferably, it is provided that the stiff intermediate element is welded to the flexible sealant.

According to an example embodiment of the present invention, the sealing device preferably includes a stiff intermediate element on each of the two sides of the flexible sealant. The at least one intermediate element is welded to the “further component” of the gas injector. When the sealing device includes two of the intermediate elements, preferably both of the stiff intermediate elements are in each case welded to a “further component” of the gas injector. These are, in particular, two different “further components” since the flexible sealant is to provide sealing between two components of the gas injector which are movable relative to one another.

The “further components,” for example the closing element or a guide sleeve in the gas injector, are usually made from a martensitically tempered material or precipitation-hardened material (second material) and thus have a corresponding (e.g., martensitic) structure, at least at the surfaces. This material is, in particular, suitable for these components since it is wear-resistant. However, the hardened material may become brittle when atomic hydrogen is present. Without the intermediate element described here, a mixed structure would arise, when welding the austenitic flexible sealant to the further component, in the melt area of the weld and in the adjoining heat-affected zone, which, in particular due to the relatively thin-walled sealant, may embrittle hydrogen and consequently may tear. The use of the intermediate element between the flexible sealant and the further component avoids having to weld the relatively thin-walled sealant directly to the further component.

According to an example embodiment of the present invention, when welding the intermediate element to the further component, a mixed structure arises in the melt area which resulted from the welding. This mixed structure may also arise in the adjoining heat-affected zone. The melt area, in particular, also the adjoining heat-affected zone, is preferably made more robust against penetrating hydrogen with the aid of a laser melting close to the surface. This is described in detail within the scope of the method according to the present invention.

The wall thickness of the flexible sealant is defined at its thinnest point. At the intermediate element, a thickness of the intermediate element is also defined at the thinnest point. In particular, the thickness of the intermediate element is measured perpendicular to a longitudinal axis of the gas injector. It is preferably provided that the thickness of the intermediate element is at least 2 times, preferably at least 3 times, particularly preferably at least 5 times the wall thickness of the sealant. In this way, a sufficiently large junction width of the weld between the intermediate element and the further component may be ensured.

Furthermore, a length of the intermediate element is defined parallel to the longitudinal axis of the gas injector. This length is preferably at least 1 mm, particularly preferably at least 3 mm.

The intermediate element is, in particular, annular and situated coaxially to the longitudinal axis of the gas injector. In particular, the intermediate element rests with its annular inner surface on the further component to which the intermediate element is welded.

As described above, the gas injector includes a closing element, which is movable back and forth between the closed and open positions using the magnetic actuator. The at least one intermediate element is preferably welded to this closing element.

Furthermore, according to an example embodiment of the present invention, the gas injector may include a guide sleeve. This guide sleeve is stationary relative to a valve housing of the gas injector. In particular, the guide sleeve is directly or indirectly joined to the valve housing. For example, the guide sleeve is welded to a valve body. The valve body, in turn, is welded to the valve housing and/or the internal pole.

The closing element extends through the guide sleeve and is linearly movably guided in the guide sleeve. Preferably, a return element, for example designed as a helical spring, is situated in the guide sleeve. The return element is designed to return the closing element into the closed state after the opening process.

According to an example embodiment of the present invention, the at least one intermediate element is preferably welded to the guide sleeve. In particular, the sealing device includes a flexible sealant and one of the stiff intermediate elements at each of the two ends. The one intermediate element is welded to the closing element, and the other intermediate element is welded to the guide sleeve.

Furthermore, according to an example embodiment of the present invention, the gas injector may include an inner body. This inner body is used, for example, to accommodate a braking device in the gas injector for decelerating the movement of the closing element. At least one lubricant channel may be configured in the inner body. The inner body is preferably stationary relative to the valve housing, for example the inner body is welded to a main body of the gas injector. This main body may, in turn, be welded to the valve housing. In addition or as an alternative, the inner body may be welded to a magnetic housing of the magnetic actuator. Preferably, a further sealing device is provided in the area of this inner body. The at least one stiff intermediate element of this further sealing device is preferably welded to the inner body.

According to an example embodiment of the present invention, an end piece may be linearly movably guided on the inner body. The further sealing device is preferably welded to a further stiff intermediate element using the end piece so that the further sealing device includes two stiff intermediate elements, one of the intermediate elements being welded to the inner body, and the other intermediate element being welded to the end piece. The flexible sealant extends between these two intermediate elements.

The present invention furthermore relates to a method for manufacturing a gas injector. This is, in particular, the above-described gas injector. According to an example embodiment of the present invention, in the method, a space in the gas injector, in particular the lubricant chamber, is sealed. For this purpose, the stiff intermediate element, which is joined to the flexible sealant, is welded to the further component of the gas injector. The flexible sealant and the intermediate element are made from the “first material,” and the further component is made from the “second material.” The two materials differ from one another, as was described within the scope of the gas injector according to the present invention. In particular, the stiff intermediate element and the flexible sealant are made from austenitic steel, and the further component has a martensitic structure, at least at its surface, or is a precipitation-hardened material.

According to an example embodiment of the present invention, particularly preferably, initially the flexible sealant is welded to at least one, preferably two, of the intermediate elements in the method. Thereafter, the intermediate element is, or the two intermediate elements are, welded to the respective associated further component.

During the welding of the intermediate element to the further component, a melt area and an adjoining heat-affected zone arise as a result of the welding. A mixed structure arises in the process in the melt area, possibly also in the heat-affected zone, since the intermediate element is made from austenitic steel, and the further component is hardened, at least at the surface. Within the scope of the method, a treatment, preferably austenitization, is carried out after the welding by melting the melt area close to the surface, possibly also the adjoining heat-affected zone. The melting close to the surface preferably takes place using a laser. After the melting, a controlled cooling preferably takes place. A heat input with the aid of the laser may also occur during this cooling process, so that the desired cooling speed for the austenitization may be controlled. This laser melting close to the surface may also homogenize the structure, reduce the residual stresses, and reduce the carbon content. As a result of this treatment of the expanded welding area, an austenitization also arises, at least partially, which increases the hydrogen robustness of the treated area. In this way, the possible diffusion of the hydrogen is reduced.

In particular, a melting with a melt depth of 2 μm to 100 μm, in particular, 5 μm to 30 μm, occurs.

Both the melt area that arose due to welding and the adjoining heat-affected zone extend both into the intermediate element and into the further component. Accordingly, it is preferably provided that the melting close to the surface for the austenitization takes place both in the area of the intermediate element and in the area of the further component.

### BRIEF DESCRIPTION OF THE DRAWINGS

One exemplary embodiment of the present invention is described in detail hereafter with reference to the figures.

FIG. 1 shows a schematic sectional view of a gas injector according to the present invention according to an exemplary embodiment of the present invention.

FIG. 2 shows a front section of the gas injector according to the present invention from FIG. 1;

FIG. 3 shows a detailed view of detail III identified in FIG. 2.

FIG. 4 shows a rear section of the gas injector according to the present invention from FIG. 1.

### DETAILED DESCRIPTION OF EXAMPLE EMBODIMENTS

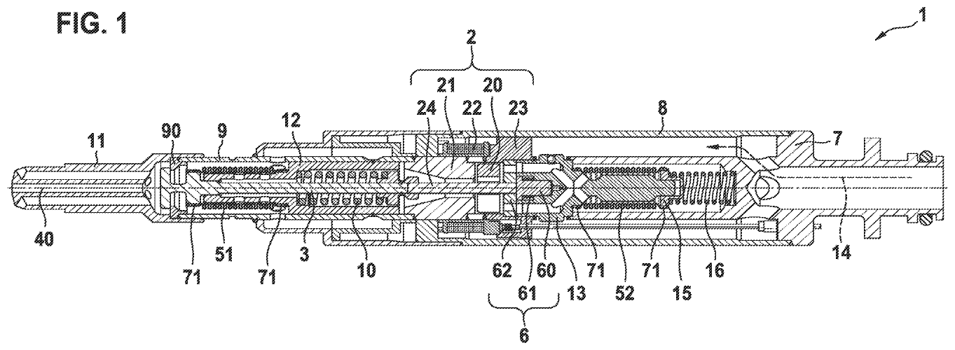

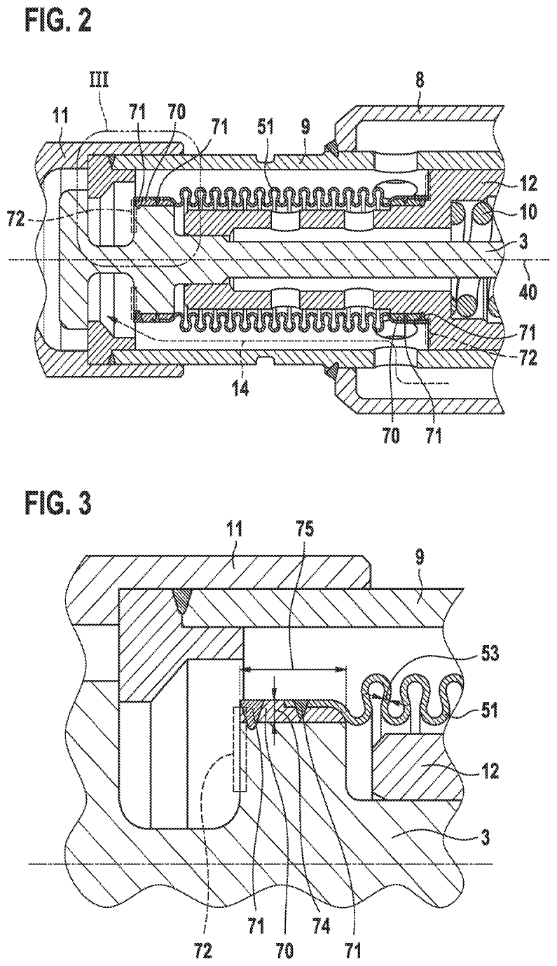

A gas injector 1 according to a preferred exemplary embodiment of the present invention is described in detail hereafter with reference to FIGS. 1 through 4. As FIG. 1 and the views in FIGS. 2 through 4 show, gas injector 1 includes a magnetic actuator 2, which moves a closing element 3, for introducing a gaseous fuel. Closing element 3 extends along a longitudinal axis 40 of gas injector 1. In the shown exemplary embodiment, closing element 3 opens to the outside. The figures show the closed state in this regard.

Magnetic actuator 2 includes an armature 20, which rests against closing element 3 with the aid of an armature pin 24. Furthermore, magnetic actuator 2 includes an internal pole 21, a coil 22, and a magnetic housing 23, which ensures a magnetic return of magnetic actuator 2.

The gas injector moreover includes a main body 7 including a rear connection, through which the gaseous fuel is supplied. A valve housing 8 is fixed to main body 7. Magnetic actuator 2 is situated in valve housing 8. A valve body 9, at the free end of which a valve seat 90 is provided in which closing element 3 unblocks and closes a passage for the gaseous fuel, adjoins valve housing 8. A head 11 including corresponding outlet openings for the gaseous fuel is situated at valve body 9.

A guide sleeve 12, to which internal pole 21 and valve housing 8 are welded, is situated in valve body 9. Guide sleeve 12 is sealed with respect to closing element 3 by a first flexible sealing element 51, in particular, a bellows. Closing element 3 extends through guide sleeve 12 and is linearly movably guided in guide sleeve 12. Inside guide sleeve 12, a return element 10, designed as a helical spring, is situated for closing element 3 in order to return it into the closed state shown in FIG. 1 again after the opening process.

Magnetic housing 23 is welded to an inner body 13. Inner body 13 is welded to main body 7. Inner body 13 is sealed with respect to an end piece 15 by a second flexible sealing element 52, in particular, a bellows. End piece 15 is linearly movably guided at inner body 13 and preloaded in the direction of inner body 13 with the aid of an elastic compensating element 16, in particular a helical spring.

The two flexible sealing elements 51, 52 seal an interior lubricant chamber in which closing element 3 and armature 20 move.

FIG. 1 schematically shows a gas path 14 through gas injector 1, which extends outside the lubrication chamber. This gas path 14 begins at main body 7 and extends through valve housing 8 radially outside magnetic actuator 2 and leads over valve body 9 to valve seat 90. When gas injector 1 is opened, the gaseous fuel flows past the outer circumference of magnetic actuator 2 and past the opened valve seat 90, into a combustion chamber or into an intake manifold. Closing element 3 thus unblocks gas path 14 at valve seat 90 and closes the valve seat.

Gas injector 1 furthermore includes a braking device 6. Braking device 6 includes a brake spring 61 on a brake pin 60 which is inserted into inner body 13. A brake guide element 62 guides armature pin 24 so that armature pin 24 may enter into operative connection with brake pin 60. Braking device 6 has the task of decelerating closing element 3, including armature 20, during a closing process of gas injector 1.

FIG. 2 shows gas injector 1 in the front area including first flexible sealing element 51. FIG. 3 shows detail III identified in FIG. 2. As these figures show, first flexible sealing element 51 is welded at its two ends in each case to an intermediate element 70. The weld seams are schematically plotted using reference numeral 71. First flexible sealing element 51, together with its two intermediate elements 70, forms a sealing device for sealing the interior lubricant chamber with respect to the exterior gas path 14.

First sealant (sealing element) 51 and the two intermediate elements 70 are each made from austenitic steel. First flexible sealant 51 is a bellows. The two intermediate elements 70 are closed rings.

Intermediate element 70 shown on the left in FIG. 2 sits on closing element 3 and is welded to closing element 3. Closing element 3 has a martensitic or precipitation-hardened structure. Accordingly, a mixed structure, e.g., including martensite, arises during the formation of weld seam 71 between intermediate element 70 and closing element 3 in the melt area and an adjoining heat-affected zone 72. For this reason, a melting 72 close to the surface, with subsequent cooling for austenitization, is preferably carried out in this melt area and the heat-affected zone after welding.

This laser melting close to the surface may also homogenize the structure, reduce the residual stresses, and reduce the carbon content. As a result of this treatment of the expanded welding area, an austenitization also arises, at least partially, which increases the hydrogen robustness of the treated area. In this way, the possible diffusion of the hydrogen is reduced.

FIG. 2 shows the weld of intermediate element 70 to guide sleeve 12 in the right area. Guide sleeve 12 also has a martensitic or precipitation-hardened structure so that a mixed structure arises in the melt area of weld seam 71 and in the adjoining heat-affected zone, which, in turn, is austenitized by melting 72 close to the surface.

FIG. 3 shows in the detailed illustration that first sealant 51 has a wall thickness 53. A thickness 74 of intermediate element 70 is defined perpendicular to longitudinal axis 40. A length 75 of intermediate element 70 is defined in parallel to longitudinal axis 40. As is explained in the general part, thickness 74 is preferably at least 2 times wall thickness 53.

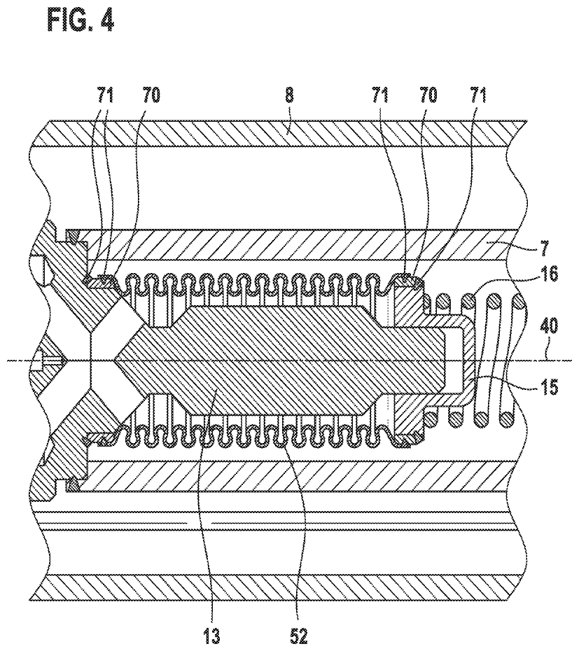

FIG. 4 shows a section of gas injector 1 including second flexible sealant 52. This second flexible sealant 52, together with two intermediate elements 70, which are also in each case designed in a closed annular shape, also forms a sealing device.

As is shown in FIG. 4, the one intermediate element 70 is welded to inner body 13. The other intermediate element 70 is welded to end piece 15. In particular, the two intermediate elements 70 and second sealant 52 are again made from austenitic steel here. Inner body 13 and/or end piece 15 have a martensitic or precipitation-hardened structure.

FIG. 4 schematically illustrates that the two intermediate elements 70 are welded by weld seams 71 to the further components, namely inner body 13 and end piece 15. For the sake of clarity, the heat-affected zones are not illustrated here; however, it is also preferably provided here that the melt areas and the heat-affected zones are austenitized by melting 72 close to the surface and subsequent cooling.

1-12. (canceled)

13. A gas injector for injecting a gaseous fuel, comprising:
a magnetic actuator including an armature, an internal pole, and a coil;
a closing element, which unblocks and closes a gas path at a valve seat, the armature being connected to the closing element; and
at least one sealing device configured to seal a space in the gas injector, the sealing device including a flexible sealant, and at least one stiff intermediate element joined to the flexible sealant, the at least one intermediate element being welded to a further component of the gas injector;
wherein the flexible sealant and the intermediate element are made from at least one first material, the further component includes a second material at least at a surface, and the at least one first material of the flexible sealant and of the intermediate element differs from the second material.

14. The gas injector as recited in claim 13, wherein the flexible sealant is welded to the intermediate element.

15. The gas injector as recited in claim 13, wherein the first material is more resistant to hydrogen embrittlement than the second material.

16. The gas injector as recited in claim 13, wherein the first material is an austenitic steel and/or the second material is a steel that is hardened at least at the surface.

17. The gas injector as recited in claim 13, wherein a melt area, which arose as a result of welding the intermediate element to the further component, and also an adjoining heat-affected zone, is austenitized by a melting, using a laser.

18. The gas injector as recited in claim 13, wherein a wall thickness at the flexible sealant is defined at a thinnest point, and a thickness at the intermediate element is defined at a thinnest point, the thickness at the intermediate element being at least 2 times the wall thickness.

19. The gas injector as recited in claim 13, wherein the flexible sealant is a bellows.

20. The gas injector as recited in claim 13, wherein the intermediate element is an intermediate ring and is welded to the closing element and/or the intermediate element is an intermediate ring welded to a guide sleeve.

21. The gas injector as recited in claim 13, wherein the sealing device is configured to seal a lubricant chamber in the gas injector.

22. A method for manufacturing a gas injector, the method comprising:
for sealing a space in the gas injector, welding a stiff intermediate element which is joined to a flexible sealant, to a further component of the gas injector, the flexible sealant and the intermediate element being made from at least one first material, and the further component including a second material at least at a surface, the at least one first material differing from the second material.

23. The method as recited in claim 22, treating, after welding, and then subsequently cooling, a melt area which arose as a result of welding the intermediate element to the further component, by melting close to a surface using a laser.

24. The method as recited in claim 23, wherein an adjoining heat-affected zone adjoining the melt area is also treated by the melting using the laser.

25. The method as recited in claim 23, wherein the melting is carried out with a melt depth of 2 μm to 100 μm.

26. The method as recited in claim 23, wherein the melting is carried out with a melt depth of 5 μm to 30 μm.
